(19) United States
(12) Patent Application Publication
(10) Pub. No.: US 2011/0055279 A1
(43) Pub. Date: Mar. 3, 2011

(54) APPLICATION SERVER, OBJECT MANAGEMENT METHOD, AND OBJECT MANAGEMENT PROGRAM

(76) Inventor: TOMOYUKI TERASAKA, Tokyo (JP)

(21) Appl. No.: 12/834,060

(22) Filed: Jul. 12, 2010

(30) Foreign Application Priority Data
Sep. 1, 2009 (JP) 2009-201550

(51) Int. Cl. G06F 17/30

(52) U.S. Cl. 707/792; 707/E17.055

(57) ABSTRACT

To improve convenience for users, the application server of the present invention has an object storage portion which stores objects in object-oriented programming; an extraction condition reception portion which receives an extraction condition to extract an object; an object extraction portion which extracts objects satisfying the received extraction condition, from the objects stored in the object storage portion; a common field specification portion which specifies an attribute name and an operation name common to the extracted objects; a group object generation portion which generates a group object by setting the specified attribute name and operation name in an attribute field and an operation field of the object, and setting the received extraction condition in an extraction condition field which is referenced when extracting objects; and a group object registration portion which registers the generated group object in the object storage portion.

This application is based upon and claims the benefit of priority from Japanese patent application No. 2009-201550, filed on Sep. 1, 2009, the disclosure of which is incorporated herein in its entirety by reference.

### BACKGROUND

This invention relates to an application server, an object management method, and an object management program.

Java (a registered trademark) Management Extensions (hereafter “JMX”) is known as a framework for management and monitoring of applications by an object-oriented program. When an object is managed by an application service conforming to the JMX specification, object attribute names and operation names can be handled by using an interface standardized by JMX. One such system is, for example, the application management system described in Japanese Patent Application Laid-open No. 2004-295463.

However, when a JMX specification interface is used to handle object attribute names and operation names, there are numerous inconveniences for users. For example, if object operation names and attribute names are displayed, all the operation names and attribute names set for an object are displayed; and even when the same operation is performed for a plurality of objects, the same operation must be repeated for each of the objects.

### SUMMARY

An exemplary object of the invention is to provide an application server, an object management method, and an object management program, which can improve convenience for users.

An application server according to an exemplary aspect of the invention includes a storage device for storing objects in object-oriented programming; reception unit for receiving an extraction condition to extract an object; extraction unit for extracting objects which satisfy the extraction condition received by the reception unit, from the objects stored in the storage device; specification unit for specifying an attribute and an operation common to the objects extracted by the extraction unit; generation unit for generating a group object by setting at least one of an attribute name and an operation name specified by the specification unit in an attribute field and an operation field of the object, and setting the extraction condition received by the reception unit in an extraction condition field of the object, which is referenced when the operation name set in the operation field is designated and executed; and registration unit for registering a group object generated by the generation unit in the storage device as an object.

An object management method according to an exemplary aspect of the invention is an object management method which is executed in an apparatus having a storage device for storing objects in object-oriented programming, and which includes a reception step of receiving an extraction condition to extract an object; an extraction step of extracting objects which satisfy the extraction condition received in the reception step, from the objects stored in the storage device; a specification step of specifying an attribute and an operation common to the objects extracted in the extraction step; a generation step of generating a group object by setting at least one of an attribute name and an operation name specified in the specification step in an attribute field and an operation field of the object, and setting the extraction condition received in the reception step in an extraction condition field of the object, which is referenced when the operation name set in the operation field is designated and executed; and a registration step of registering a group object generated in the generation step in the storage device as an object.

An object management program according to an exemplary aspect of the invention causes a computer to execute each of the steps contained in the above object management method.

### DESCRIPTION OF THE DRAWINGS

FIG. 1 is a block diagram showing the functional configuration of the application server of an embodiment;

FIG. 2 schematically shows processing content when registering a group object;

FIG. 3 is a flowchart showing a processing sequence when registering a group object;

FIG. 4 schematically shows processing content when performing batch operations on objects belonging to a group object;

FIG. 5 is a flowchart showing a processing sequence when performing batch operations on objects belonging to a group object;

FIG. 6 is a flowchart showing a processing sequence when performing batch modification of attributes and operations of objects belonging to a group object;

FIG. 7 schematically shows processing content when registering a group object in a modified example; and

FIG. 8 schematically shows processing content when performing batch operations on objects belonging to a group object in a modified example.

### EXEMPLARY EMBODIMENT

Below, preferred embodiments of an application server of the invention are explained, referring to the attached drawings.

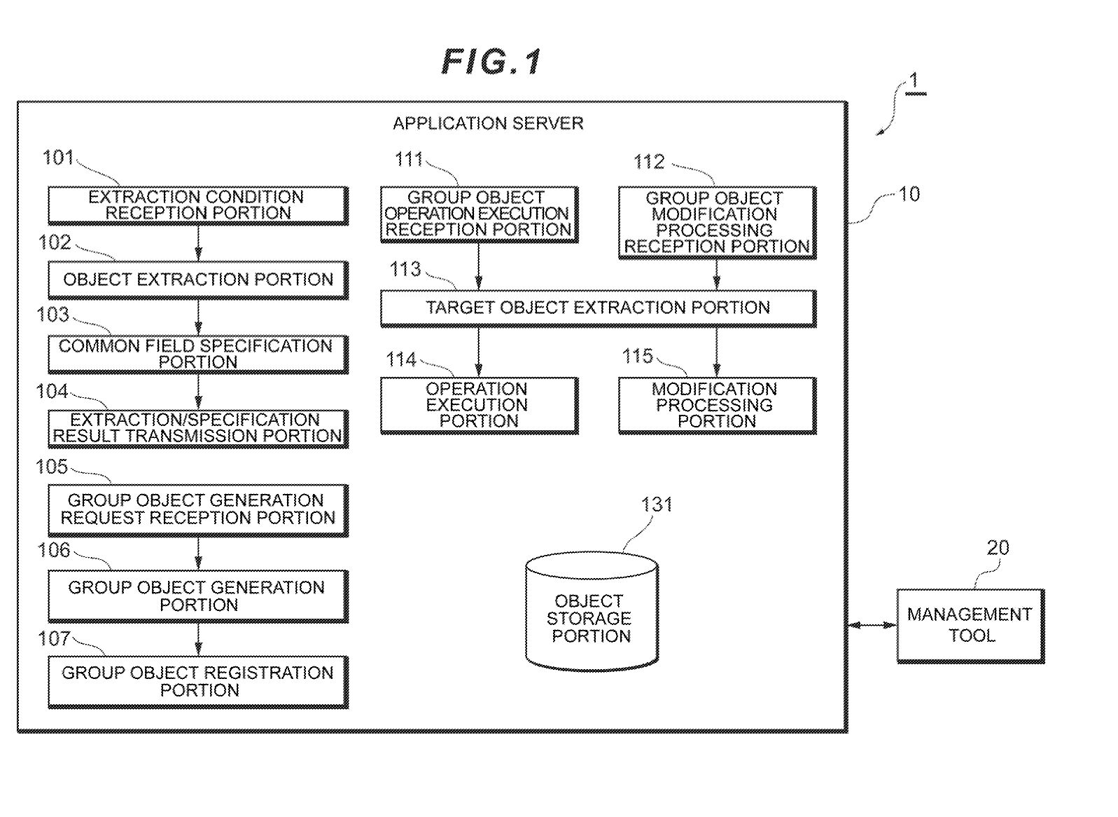

First, the configuration of an application management system including an application server is explained, referring to FIG. 1.

As shown in FIG. 1, the application management system 1 comprises an application server 10 and a management tool 20. JMX is installed on the application server 10. The application server 10 manages objects in object-oriented programming. The management tool 20 is a tool used when a user handles objects of the application server 10. The management tool 20 includes an interface which is standardized in JMX.

Referring to FIG. 1, the functional configuration of the application server of this embodiment is explained. The application server 10 has an extraction condition reception portion (reception unit) 101; an object extraction portion (extraction unit) 102; a common field specification portion (specification unit) 103; an extraction/specification result transmission portion (transmission unit) 104; a group object generation request reception portion (generation request reception unit, hereafter called the “GO generation request reception portion”) 105; a group object generation portion (generation unit, hereafter called the “GO generation portion”) 106; and a group object registration portion (registration unit, hereafter called the “GO registration portion”) 107.

Further, the application server 10 further has a group objection operation execution reception portion (hereafter called the “GO operation execution reception portion”) 111, a group object modification processing reception portion (hereafter called the “GO modification processing reception portion”) 112, a target object extraction portion (extraction-during-operation unit, extraction-upon-modification unit) 113, an operation execution portion (execution unit) 114, and a modification processing portion (modification unit) 115. The application server 10 comprises an object storage portion (storage device) 131, which stores objects.

An object is provided with fields in which to set various kinds of information. Setting fields may be, for example, an object name field, an attribute field, an operation field, and an extraction condition field. An object name which uniquely specifies the object is set in the object name field. Further, the object type can also be set in the object name field. Object types may for example be “application”, “resource”, and “service”. An attribute (data) name and operation (method) name which are necessary when using a service provided by an object are respectively set in the attribute field and in the operation field. An attribute name may be, for example, “state”, representing the state of an object. Operation names may be, for example, “start”, to start a service; “stop”, to stop a service; “query”, to query an object; “create”, to register an object; and “delete”, to delete an object. An extraction condition (data) when executing a “query” operation is set in the extraction condition field.

The extraction condition reception portion 101 receives, from the management tool 20, an extraction condition to extract a prescribed object from the object storage portion 131. An extraction condition is a condition for a user to extract a desired object from the object storage portion 131. Extraction conditions can for example be expressed by a character string which is a regular expression for the object name of the object which is the extraction target. Specifically, when extracting an object having an object name the “name” key of which is an arbitrary value, and the “type” key of which is “application”, “name=*, type=application” is the extraction condition. Such extraction conditions can for example be set by a user using the management tool 20 when executing a “query” operation on an extraction/generation object.

The object extraction portion 102 extracts from the object storage portion 131 objects satisfying the extraction condition received by the extraction condition reception portion 101.

The common field specification portion 103 specifies attribute names and operation names common to objects extracted by the object extraction portion 102.

The extraction/specification result transmission portion 104 transmits to the management tool 20 the object names of objects extracted by the object extraction portion 102, and attribute names and operation names specified by the common field specification portion 103.

The GO generation request reception portion 105 receives group object generation requests from the management tool 20. A generation request is a message issued when requesting that a group object be generated. A generation request includes, for example, the object name of the generated group object, an attribute name and operation name, and an object name extraction condition, used when extracting objects belonging to the group object itself. An object name arbitrarily designated by the user is set as the object name of the generation request. The common attribute name and operation name specified by the common field specification portion 103 are set as the attribute name and operation name of the generation request. The extraction condition received by the extraction condition reception portion 101 is set as the extraction condition of the generation request. Such information included in the generation request can for example be set by the user using the management tool 20 at the time of execution of the “create” operation of the extraction/generation object.

Optionally, a generation request can further include an attribute name and operation name extraction condition, arbitrarily selected by the user from among common attribute names and operation names. By this means, when extracting objects belonging to the object group itself, the attribute names and operation names of the objects which are extraction targets are limited to the attribute name and operation name designated by the extraction condition.

The GO generation portion 106 generates a group object based on the information included in the generation request. Specifically, the GO generation portion 106 sets the group object name included in the generation request in the object name field of a group object, and sets the attribute name and operation name included in the generation request in the attribute field and operation field of the group object. Further, the GO generation portion 106 sets the object name extraction condition included in the generation request in the extraction condition field of the group object. Optionally, when an attribute name and operation name extraction condition is included in the generation request, the GO generation portion 106 additionally sets the attribute name and operation name extraction condition included in the generation request in the extraction condition field of the group object.

The GO registration portion 107 registers the group object generated by the GO generation portion 106 in the object storage portion 131.

When a group object operation has been executed by the user using the management tool 20, the GO operation execution reception portion 111 receives from the management tool 20 an operation execution message indicating that a group object operation has been executed. The operation execution message includes, for example, the object name of the group object for which an operation was executed, and the name of the executed operation.

When either the attribute name or the operation name content of a group object is modified by a user using the management tool 20, the GO modification processing reception portion 112 receives from the management tool 20 a modification message indicating that the attribute name and operation name content of the group object has been modified. The modification message includes, for example, the object name of the modified group object and the modified content. The attribute name and operation name content includes the content of the attribute name and operation name themselves, and the content of a module specified by the attribute name and operation name.

When an operation execution message or a modification message has been received by the GO operation execution reception portion 111 or the GO modification processing reception portion 112, the target object extraction portion 113 extracts, from the object storage portion 131, objects satisfying the extraction condition set in the extraction condition field of the group object.

The operation execution portion 114 designates and executes the same operation name as the operation name included in an operation execution message, among the operation names set in the operation field of objects extracted by the target object extraction portion 113.

The modification processing portion 115 modifies the content of the attribute name and operation name set in the attribute field and operation field of objects extracted by the target object extraction portion 113, according to modification content included in a modification message.

Here, the application server 10 physical includes a CPU, memory, and input/output interface. Memory includes, for example, ROM and a HDD to store programs and data processed by the CPU, and RAM used primarily as various working areas for control processing. These elements are interconnected via a bus. The CPU executes programs stored in ROM, and, using various messages received via the input/output interface and various data expanded in RAM to perform processing, can realize the functions of each of the portions in the above-described application server 10.

Next, drawings are referenced to explain action of the application server 10 in this embodiment.

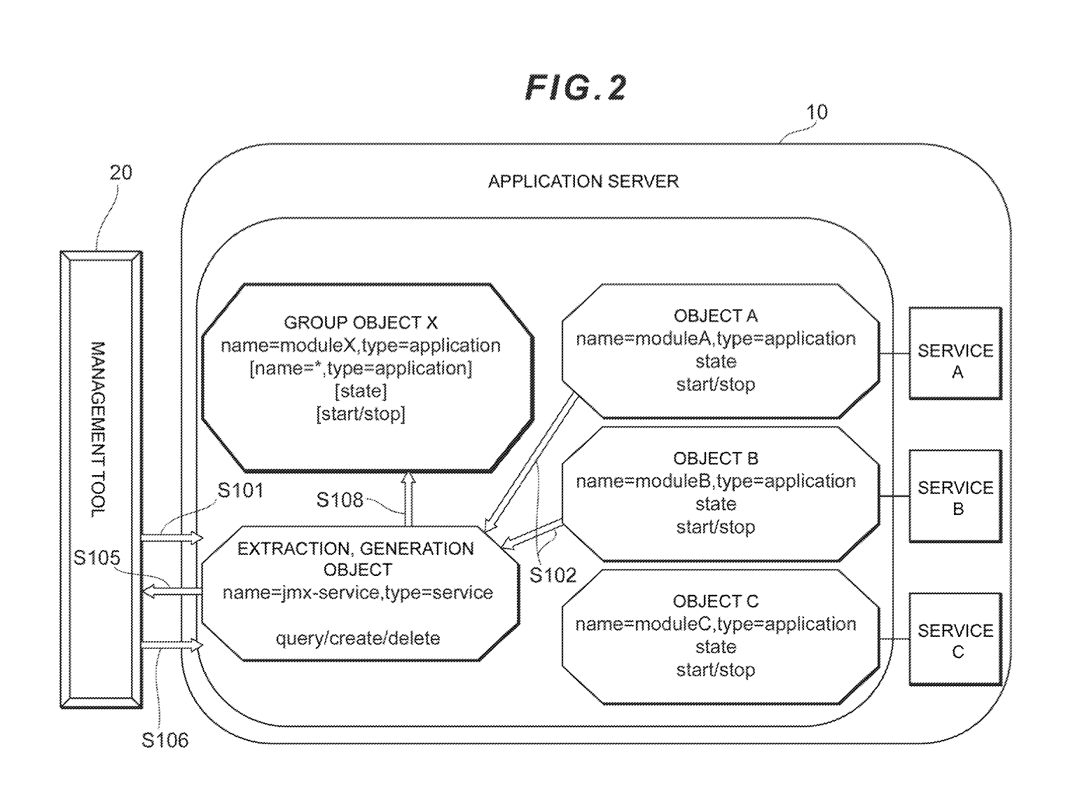

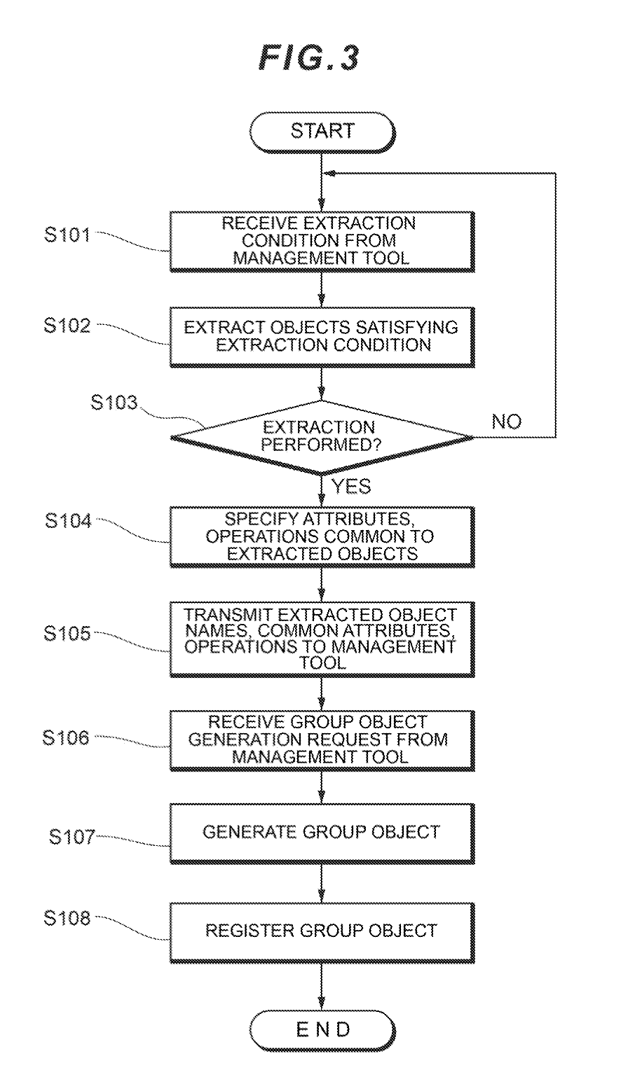

First, action is explained when registering a group object, referring to FIG. 2 and FIG. 3. FIG. 2 schematically shows processing content when registering a group object. FIG. 3 is a flowchart showing a processing sequence when registering a group object.

In explaining action, for convenience of explanation, it is assumed that an object A, object B, and object C are being registered in the object storage portion 131 of the application server 10 in order to execute a service A, service B, and service C.

“ModuleA” is set in the object name field of object A, “application” is set in the object type field, “state” is set in the attribute field, and “start” and “stop” are set in the operation field. “ModuleB” is set in the object name field of object B, “application” is set in the object type field, “state” is set in the attribute field, and “start” and “stop” are set in the operation field. “ModuleC” is set in the object name field of object C, “resource” is set in the object type field, “state” is set in the attribute field, and “start” and “stop” are set in the operation field.

Further, in the object storage portion 131 is registered an extraction/generation object which is used when extracting objects and when generating objects in the application server 10. “Jmx-service” is stored in the object name field of the extraction/generation object, “service” is set as the object name field, and “query”, “create” and “delete” are set in the operation field. In FIG. 2, a group object X, generated by action when registering the group object explained below, is already shown. Below, action at the time of registering this group object X is explained.

First, when the user uses the management tool 20 to execute the “query” operation of the extraction/generation object, the extraction condition reception portion 101 of the application server 10 receives from the management tool 20 an extraction condition issued by the “query” operation (step S101). It is assumed that in this action, “name=*, type=application” is received as the extraction condition.

Then, the object extraction portion 102 of the application server 10 extracts from the object storage portion 131 the objects satisfying the extraction condition received by the extraction condition reception portion 101 (step S102). In this action, the object A and the object B are extracted by the extraction/generation object.

Then, the common field specification portion 103 of the application server 10 specifies the attribute names and operation names which are common to the objects extracted by the object extraction portion 102 (step S104). In this action, “state”, “start”, and “stop” are specified by the extraction/generation object as the common attribute name and operation names.

Then, the extraction/specification result transmission portion 104 of the application server 10 transmits to the management tool 20 the object names of the objects extracted in step S102 above, and the common attribute name and operation names specified in step S104 above (step S105). By this means, “moduleA” and “moduleB”, which are the object names of object A and object B, and “state”, “start”, and “stop”, which are the common attribute name and operation names of object A and object B, are displayed on a screen of the management tool 20. That is, the user can confirm only the attribute names and operation names common to the objects which are to be targets for grouping.

Then, when the user uses the management tool 20 to execute the “create” operation of the extraction/generation object, the GO generation request reception portion 105 of the application server 10 receives from the management tool 20 a group object generation request issued by the “create” operation (step S106). In this action, in the “create” action, “name=moduleX, type=application” is designated as the group object name, “state” is designated as an attribute name of the group object, “start” and “stop” are designated as operation names of the group object, and “name=*, type=application” is designated as the extraction condition of objects belonging to the group itself. Each of the above pieces of information designed by the “create” operation is included in the generation request.

Then, the GO generation portion 106 of the application server 10 generates a group object based on each of the pieces of information included in the generation request (step S107). By this means, the group object X is generated.

Then, the GO registration portion 107 registers the generated group object X in the object storage portion 131 (step S108).

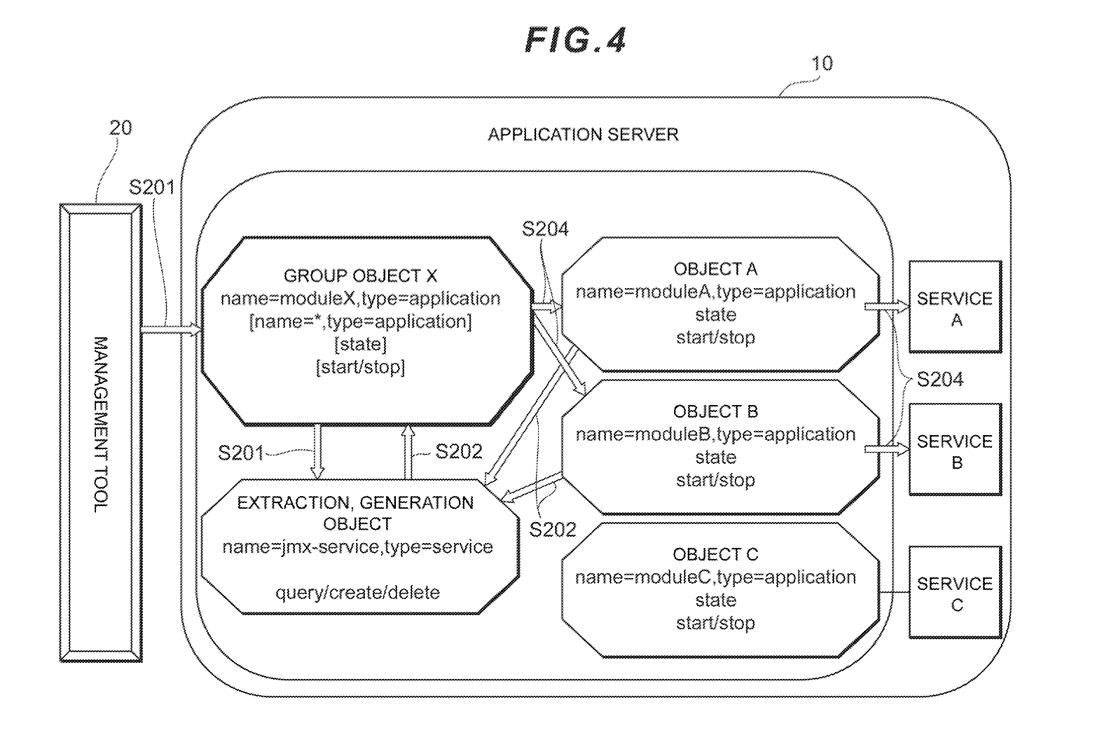

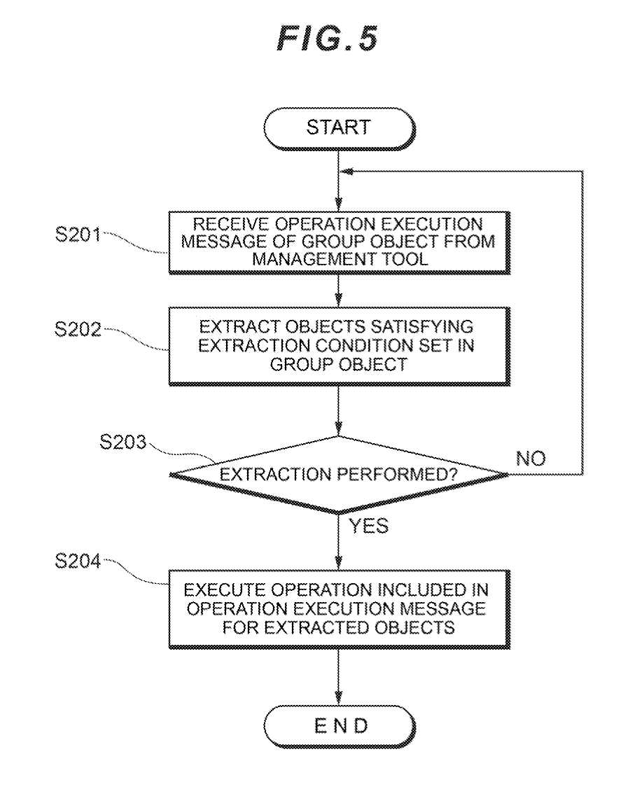

Next, action during a batch operation on objects belonging to a group is explained, referring to FIG. 4 and FIG. 5. FIG. 4 schematically shows processing content when performing batch operations on objects belonging to a group object. FIG. 5 is a flowchart showing a processing sequence when performing batch operations on objects belonging to a group object.

First, when the user uses the management tool 20 to execute the “start” operation of the group object X, the GO operation execution reception portion 111 of the application server 10 receives from the management tool 20 an operation execution message issued by the “start” operation (step S201). This operation execution message includes “name=moduleX, type=application” as the object name of the group object X, and “start” as the executed operation name.

Then, the target object extraction portion 113 of the application server 10 extracts from the object storage portion 131 the objects satisfying the extraction conditions set in the extraction condition field of group object X (step S202). In this action, the “query” operation of the extraction/generation object is executed, based on the “name=*, type=application” object name extraction condition set in the extraction condition field of the group object X. By this means, object A and object B are extracted. Instead of the “query” operation of the extraction/generation object, the “query” operation of the group object may be executed.

Then, the operation execution portion 114 of the application server 10 designates and executes the same operation name as the operation name included in the operation execution message received in step S201 above, among the operation names set in the operation field of the objects extracted in step S202 above (step S204). In this action, the “start” operation of object A and the “start” operation of object B are each executed. By this means, service A and service B each begin operation.

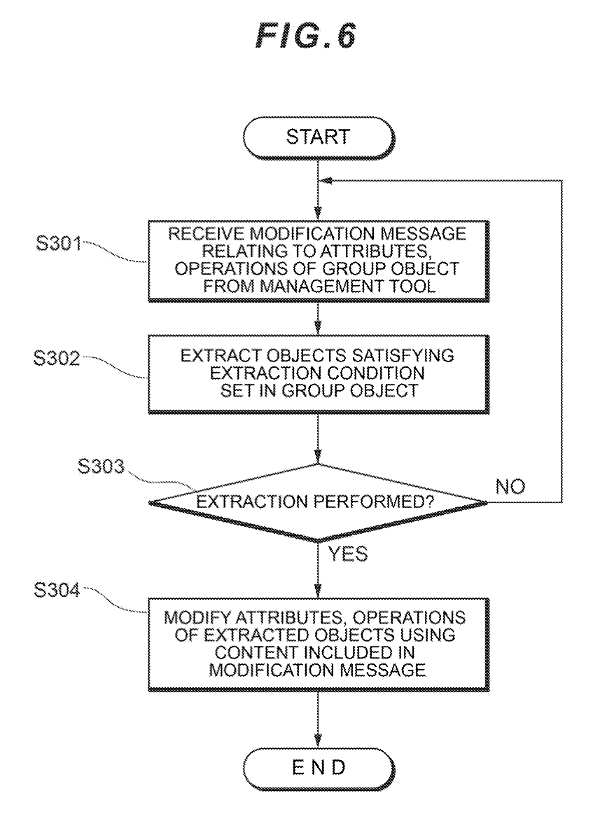

Next, action during batch modification of the attribute names and operation names of objects belonging to a group is explained, referring to FIG. 6. FIG. 6 is a flowchart showing a processing sequence when performing batch modification of attributes and operations of objects belonging to a group object.

First, when the user uses the management tool 20 to modify the content of one of the attribute names and the operation names of the group object X, the GO modification processing reception portion 112 of the application server 10 receives from the management tool 20 a modification message issued by modification processing (step S301). This modification message includes the modification content for the attribute names and operation names of the group object X.

Then, the target object extraction portion 113 of the application server 10 extracts from the object storage portion 131 the objects satisfying the extraction condition set in the extraction condition field of the group object X (step S302). In this action, the “query” operation of the extraction/generation object is executed, based on the “name=*, type=application” object name extraction condition set in the extraction condition field of the group object X. By this means, object A and object B are extracted.

Then, the modification processing portion 115 of the application server 10 modifies the content of the attribute names and operation names set in the attribute field and operation field of the objects extracted in step S302 above, according to the modification content included in the modification message received in step S301 above (step S304).

As stated above, by means of the application server 10 of this embodiment, objects extracted using conditions designated by the user can be grouped, and only the attribute names and operation names common to the grouped objects can be provided. By this means, taking all the objects conforming to JMX as targets, group objects can be generated and registered using arbitrary conditions specified by the user without modifying existing objects, and moreover only the attribute names and operation names required by the user can be provided to the user. Thus convenience for users can be improved.

Further, by executing an operation name of a group object, batch execution of the same operation name can be performed for each object belonging to the group object, and by modifying the content of the attribute names and operation names of a group object, batch modification of the content of the attribute names and operation names of each of the objects belonging to the group object can be performed. By this means, convenience for users can be further improved.

The above-described embodiment is merely an example, and does not exclude various alterations and applications of technology which are not made explicit in the embodiment. That is, this invention can be, altered variously without deviating from the gist thereof.

For example, in the above-described embodiment the invention is implemented using a single application server, but the invention can also be implemented using a plurality of application servers. In this case, the functions of the application server in the embodiment described above may be distributed among a plurality of application servers, and the group of application servers may be made to function similarly to the application server in the embodiment described above.

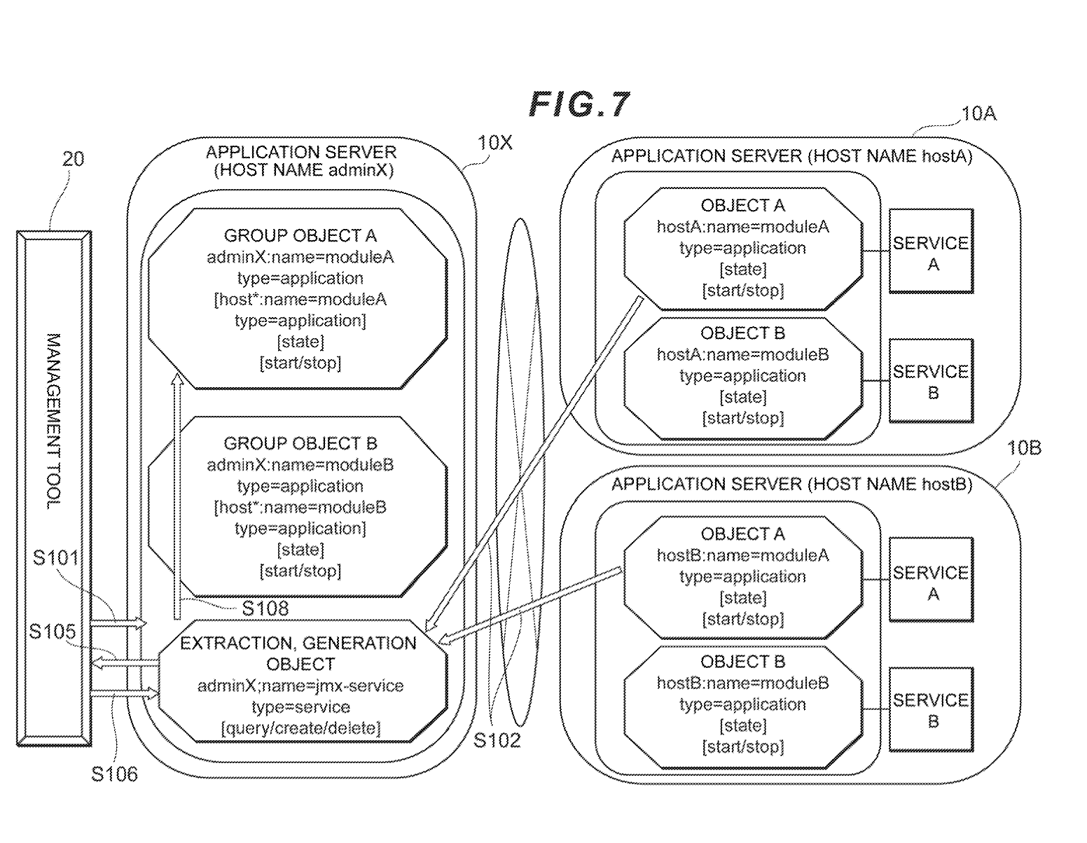

The plurality of application servers in this modified example are explained referring to FIG. 7. FIG. 7 schematically shows processing content when registering a group object in this modified example.

As shown in FIG. 7, in this modified example, an application server group is formed from an application server 10X, an application server 10A, and an application server 10B. The JMX installed on each of the application servers 10X, 10A, 10B are capable of mutual communication via a network. The host names (domains) of the servers are adminX, hostA, hostB. The application server 10X has functions for managing group objects. The application servers 10A and 10B have functions for managing objects belonging to group objects.

The same objects A and B are registered in the object storage portions 131 of the application servers 10A and 10B. That is, in each of the application servers 10A and 10B, the same services A and B are both in operation. The contents of the object A and the object B are similar to those of the above-described embodiment. However, because the same objects A and B are registered in each of the application servers 10A and 10B, when each object is specified, unique specification is performed by designating the domain (host name). For example, the object A of the application server 10A can be uniquely specified by designating “hostA:name=moduleA”, and the object A of the application server 10B can be uniquely specified by designating “hostB:name=moduleA”. The extraction/generation object used when extracting objects and when generating objects is registered in the object storage portion 131 of the application server 10X. The content of the extraction/generation object is similar to that of the above-described embodiment. Group objects are registered in the object storage portion 131 of the application server 10X. In FIG. 7, the group object A and group object B are already registered as group objects.

Action during registration of a group object in this modified example is explained referring to FIG. 3 and FIG. 7.

First, when the user uses the management tool 20 to execute the “query” operation of the extraction/generation object, the extraction condition reception portion 101 of the application server 10X receives from the management tool 20 an extraction condition issued by the “query” operation (step S101). In this action, it is assumed that “host=*:name=moduleA, type=application” is received as the extraction condition. This extraction condition is a condition to extract objects having an object name in which the domain starts with “host”, the “name” key is “moduleA” and the “type” key is “application”.

Then, the object extraction portion 102 of the application server 10X extracts objects satisfying the extraction condition received by the extraction condition reception portion 101 from both the object storage portion 131 of the application server 10A, and from the object storage portion 131 of the application server 10B (step S102). In this action, the object A of the application server 10A and the object A of the application server 10B are each extracted by the extraction/generation object.

Then, the common field specification portion 103 of the application server 10X specifies the common attribute names and operation names of objects extracted by the object extraction portion 102 (step S104). In this action, “state”, “start”, and “stop” are specified as common attribute names and operation names by the extraction/generation object.

Then, the extraction/specification result transmission portion 104 of the application server 10X transmits to the management tool 20 the object names of objects extracted in step S102 above and the common attribute names and operation names specified in step S104 above (step S105). By this means, “hostA:name=moduleA” and “hostB:name=moduleA” which are the object names of object A, and “state”, “start”, and “stop”, which are the attribute names and operation names of object A, are displayed on a screen of the management tool 20.

Then, when the user uses the management tool 20 to execute the “create” operation of the extraction/generation object, the GO generation request reception portion 105 of the application server 10X receives from the management tool 20 a group object generation request issued by the “create” operation (step S106). In this action, it is assumed that in the “create” operation, “adminX:name=moduleA, type=application” is designated as the group object name, “state” is designated as an attribute name of the group object, “start” and “stop” are designated as operation names of the group object, and “host*:name=moduleA, type=application” is designated as the extraction condition of objects belonging to the group object itself. The generation request includes each of the above pieces of information designated in the “create” operation.

Then, the GO generation portion 106 of the application server 10X generates a group object based on each of the pieces of information included in the generation request (step S107). By this means, the group object A is generated.

Then, the GO registration portion 107 registers the generated group object A in the object storage portion 131 of the application server 10X (step S108).

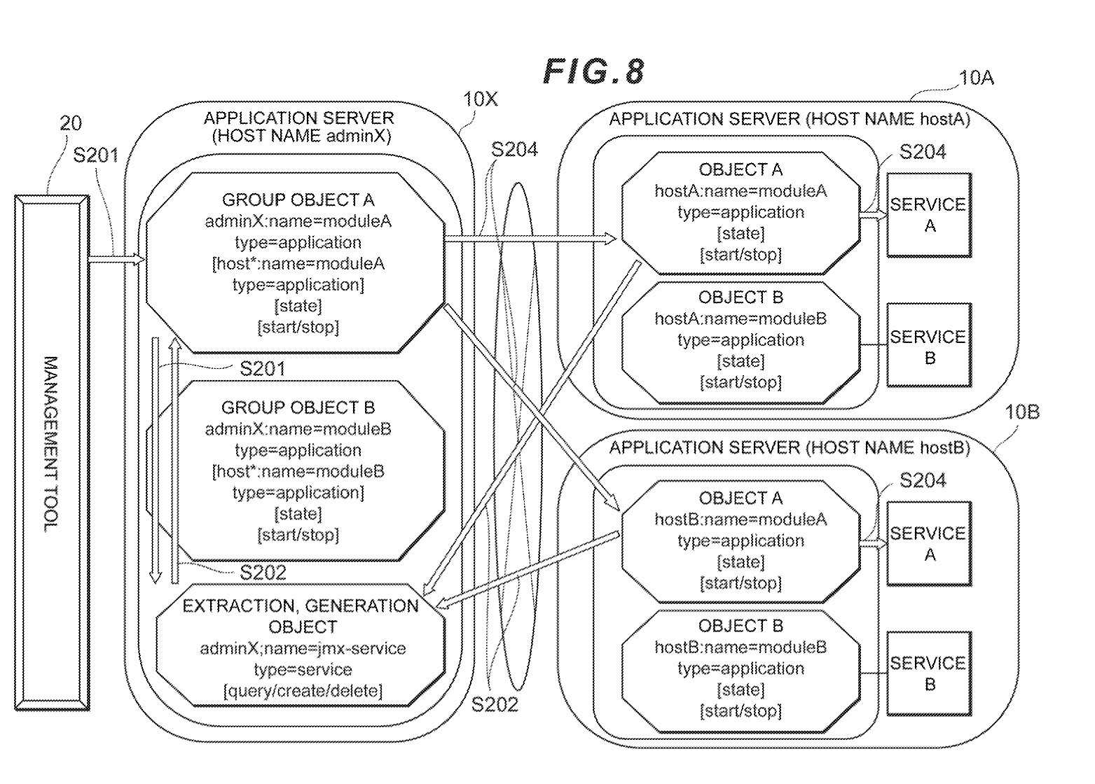

Next, action during batch operations on objects belonging to a group object in this modified example is explained, referring to FIG. 5 and FIG. 8. FIG. 8 schematically shows processing content when performing batch operations on objects belonging to a group object in this modified example.

First, when the user uses the management tool 20 to execute the “start” operation of the group object A, the operation execution reception portion 111 of the application server 10X receives from the management tool 20 an operation execution message issued by the “start” operation (step S201). This operation execution message includes “adminX:name=moduleA, type=application” which is the object name of the group object A, and “start” which is the executed operation name.

Then, the target object extraction portion 113 of the application server 10X extracts, from the object storage portion 131 of the application server 10A and from the object storage portion 131 of the application server 10B, objects satisfying the extraction condition set in the extraction condition field of the group object A (step S202). In this action, the “query” operation of the extraction/generation object is executed, based on the “host*:name=moduleA, type=application” object name extraction condition set in the extraction condition field of the group object A. By this means, the object A of the application server 10A and the object A of the application server 10B are each extracted.

Then, the operation execution portion 114 of the application server 10X executes the same operation name as the operation name included in the operation execution message received in step S201 above, among the operations set in the operation field of the objects extracted in step S202 above (step S204). In this action, the “start” operation of the object A of the application server 10A, and the “start” operation of the object A of the application server 10B, are both executed. By this means, service A in application server 10A, and service A in application server 10B, are both in operation.

Next, action during batch modification of attribute names and operation names of objects belonging to a group object in this modified example is explained, referring to FIG. 6.

First, when the user uses the management tool 20 to modify the attribute names and operation names of the group object A, the GO modification processing reception portion 112 of the application server 10X receives from the management tool 20 a modification message issued by the modification processing (step S301). This modification message includes the modified contents of attribute names and operation names; among the attribute names and operation names of the group object A.

Then, the target object extraction portion 113 of the application server 10X extracts, from the object storage portion 131 of the application server 10A and from the object storage portion 131 of the application server 10B, the objects satisfying the extraction condition set in the extraction condition field of the group object A (step S302). In this action, the “query” operation of the extraction/generation object is executed, based on the “host*:name=moduleA, type=application” object name extraction condition set in the extraction condition field of the group object A. By this means, the object A of the application server 10A and the object A of the application server 10B are each extracted.

Then, the modification processing portion 115 of the application server 10X modifies the attribute names and operation names set in the attribute field and operation field of the objects extracted in step S302 above, using the content included in the modification message received in step S301 above (step S304).

Finally, the application servers 10 explained in the above-described embodiment and modified example comprise the elements shown in FIG. 1, but an application server 10 need not necessarily comprise all these elements. For example, an application server 10 may comprise at least an extraction condition reception portion 101, object extraction portion 102, common field specification portion 103, group object generation portion 106, group object registration portion 107, and object storage portion 131.

By means of such an application server 10, objects satisfying an object extraction condition designated by a user can be extracted from an object storage portion 131, and a group object having the attribute names and operation names common to the extracted objects and the above extraction condition can be generated and registered in the object storage portion 131. By this means, specific attribute names and operation names of objects can be referenced using a group object, batch modification of specific attribute names and operation names of objects can be performed, and specific operation names of objects can be batch executed. That is, convenience for users can be improved.

An exemplary advantage according to the invention is, convenience for users can be improved.

The whole or part of the exemplary embodiments disclosed above can be described as, but not limited to, the following supplementary notes.

(Supplementary note 1) An application server, including: a storage device for storing objects in object-oriented programming; reception unit for receiving an extraction condition to extract an object; extraction unit for extracting objects which satisfy the extraction condition received by the reception unit, from the objects stored in the storage device; specification unit for specifying an attribute name and an operation name common to the objects extracted by the extraction unit; generation unit for generating a group object by setting at least one of the attribute name and the operation name specified by the specification unit in an attribute field and an operation field of the object, and setting the extraction condition received by the reception unit in an extraction condition field of the object, which is referenced when the operation name set in the operation field is designated and executed; and registration unit for registering the group object generated by the generation unit in the storage device as the object.

(Supplementary note 2) The application server according to Supplementary note 1, further including transmission unit for transmitting, to outside, an object name of the object extracted by the extraction unit, and the attribute name and the operation name specified by the specification unit.

(Supplementary note 3) The application server according to Supplementary note 1 or Supplementary note 2, further including generation request reception unit for receiving a generation request, which designates at least one of an object name of the group object and the attribute name and the operation name specified by the specification unit, and requests generation of the group object, wherein the generation unit generates the group object by setting the object name included in the generation request in an object name field of the object, and setting the attribute name and the operation name included in the generation request in the attribute field and the operation field of the object.

(Supplementary note 4) The application server according to any one of Supplementary notes 1 through 3, further including: extraction-during-operation unit for extracting, from the objects stored in the storage device, an object satisfying the extraction condition set in the extraction condition field of the group object, when the operation name set in the operation field of the group object is designated and executed as an operation on the group object; and execution unit for designating and causing to be executed the same operation name as the executed operation name, among the operation names set in the operation field of the object extracted by the extraction-during-operation unit.

(Supplementary note 5) The application server according to any one of Supplementary notes 1 through 4, further including: extraction-upon-modification unit for extracting, from the objects stored in the storage device, an object satisfying the extraction condition set in the extraction condition field of the group object, when the content of either one of the attribute name and the operation name set in the attribute field and the operation field of the group object is modified; and modification unit for modifying the content of the attribute name and operation name set in the attribute field and the operation field of the object extracted by the extraction-upon-modification unit, according to the content of either one of the attribute name and the operation name that has been modified.

(Supplementary note 6) An object management method, executed in an apparatus having a storage device for storing objects in object-oriented programming, the object management method including the steps of: receiving an extraction condition to extract an object; extracting objects which satisfy the extraction condition received in the reception step, from the objects stored in the storage device; specifying an attribute name and an operation name common to the objects extracted in the extraction step; generating a group object by setting at least one of the attribute name and the operation name specified in the specification step in an attribute field and an operation field of the object, and setting the extraction condition received in the reception step in an extraction condition field of the object, which is referenced when the operation name set in the operation field is designated and executed; and registering the group object generated in the generation step in the storage device as the object.

(Supplementary note 7) An object management program, which causes a computer to execute each of the steps described in Supplementary note 6.

(Supplementary note 8) An application server, including: a storage device for storing objects in object-oriented programming; reception means for receiving an extraction condition to extract an object; extraction means for extracting objects which satisfy the extraction condition received by the reception means, from the objects stored in the storage device; specification means for specifying an attribute name and an operation name common to the objects extracted by the extraction means; generation means for generating a group object by setting at least one of the attribute name and the operation name specified by the specification means in an attribute field and an operation field of the object, and setting the extraction condition received by the reception unit in an extraction condition field of the object, which is referenced when the operation name set in the operation field is designated and executed; and registration means for registering the group object generated by the generation means in the storage device as the object.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An application server, comprising:
a storage device for storing objects in object-oriented programming;
reception unit for receiving an extraction condition to extract an object;
extraction unit for extracting objects which satisfy the extraction condition received by the reception unit, from the objects stored in the storage device;
specification unit for specifying an attribute name and an operation name common to the objects extracted by the extraction unit;
generation unit for generating a group object by setting at least one of the attribute name and the operation name specified by the specification unit in an attribute field and an operation field of the object, and setting the extraction condition received by the reception unit in an extraction condition field of the object, which is referenced when the operation name set in the operation field is designated and executed; and
registration unit for registering the group object generated by the generation unit in the storage device as the object.

2. The application server according to claim 1, further comprising transmission unit for transmitting, to outside, an object name of the object extracted by the extraction unit, and the attribute name and the operation name specified by the specification unit.

3. The application server according to claim 1, further comprising generation request reception unit for receiving a generation request, which designates at least one of an object name of the group object and the attribute name and the operation name specified by the specification unit, and requests generation of the group object, wherein
the generation unit generates the group object by setting the object name included in the generation request in an object name field of the object, and setting the attribute name and the operation name included in the generation request in the attribute field and the operation field of the object.

4. The application server according to claim 1, further comprising:
extraction-during-operation unit for extracting, from the objects stored in the storage device, an object satisfying the extraction condition set in the extraction condition field of the group object, when the operation name set in the operation field of the group object is designated and executed as an operation on the group object; and
execution unit for designating and causing to be executed the same operation name as the executed operation name, among the operation names set in the operation field of the object extracted by the extraction-during-operation unit.

5. The application server according to claim 1, further comprising:
extraction-upon-modification unit for extracting, from the objects stored in the storage device, an object satisfying the extraction condition set in the extraction condition field of the group object, when the content of either one of the attribute name and the operation name set in the attribute field and the operation field of the group object is modified; and
modification unit for modifying the content of the attribute name and operation name set in the attribute field and the operation field of the object extracted by the extraction-upon-modification unit, according to the content of either one of the attribute name and the operation name that has been modified.

6. An object management method, executed in an apparatus having a storage device for storing objects in object-oriented programming, the object management method comprising the steps of:
receiving an extraction condition to extract an object;
extracting objects which satisfy the extraction condition received in the reception step, from the objects stored in the storage device;
specifying an attribute name and an operation name common to the objects extracted in the extraction step;
generating a group object by setting at least one of the attribute name and the operation name specified in the specification step in an attribute field and an operation field of the object, and setting the extraction condition received in the reception step in an extraction condition field of the object, which is referenced when the operation name set in the operation field is designated and executed; and
registering the group object generated in the generation step in the storage device as the object.

7. An object management program, which causes a computer to execute each of the steps described in claim 6.

8. An application server, comprising:
a storage device for storing objects in object-oriented programming;
reception means for receiving an extraction condition to extract an object;
extraction means for extracting objects which satisfy the extraction condition received by the reception means, from the objects stored in the storage device;
specification means for specifying an attribute name and an operation name common to the objects extracted by the extraction means;
generation means for generating a group object by setting at least one of the attribute name and the operation name specified by the specification means in an attribute field and an operation field of the object, and setting the extraction condition received by the reception unit in an extraction condition field of the object, which is referenced when the operation name set in the operation field is designated and executed; and
registration means for registering the group object generated by the generation means in the storage device as the object.
